(19) United States
(12) Patent Application Publication
(10) Pub. No.: US 2024/0300383 A1
(43) Pub. Date: Sep. 12, 2024

(54) THERMAL MANAGEMENT SYSTEM

(71) Applicant: TOYOTA JIDOSHA KABUSHIKI KAISHA, Toyota-shi (JP)

(72) Inventor: Tomoaki SUZUKI, Nagoya-shi (JP)

(73) Assignee: TOYOTA JIDOSHA KABUSHIKI KAISHA, Toyota-shi (JP)

(21) Appl. No.: 18/588,530

(22) Filed: Feb. 27, 2024

(30) Foreign Application Priority Data
Mar. 9, 2023 (JP) 2023-036613

(51) Int. Cl. B60L 58/27; B60L 3/00

(52) U.S. Cl. CPC B60L 58/27; B60L 3/0046; B60L 2240/545

(57) ABSTRACT

A thermal management system includes: a first flow path, a second flow path, a third flow path, and a fourth flow path; an electrical storage device configured to exchange heat with the heat medium in the first flow path; a drive device configured to exchange heat with the heat medium in the second flow path; a radiator located in the third flow path; a chiller device located in the fourth flow path; and a switching device. The switching device is configured to cause a switching circuit to be formed. In the switching circuit, the first flow path is disconnected from and independent of the second flow path, the third flow path, and the fourth flow path, the second flow path is connected to the fourth flow path, and the third flow path is disconnected from and independent of the second flow path and the fourth flow path.

### CROSS-REFERENCE TO RELATED APPLICATION

This application claims priority to Japanese Patent Application No. 2023-036613 filed on Mar. 9, 2023, incorporated herein by reference in its entirety.

### BACKGROUND

### 1. Technical Field

The present disclosure relates to a thermal management system.

### 2. Description of Related Art

Japanese Unexamined Patent Application Publication No. 2010-272395 (JP 2010-272395 A) discloses an electrified vehicle. The electrified vehicle includes an electrical storage device (battery), an inverter, and a motor. The electrical storage device is connected to the inverter. The motor is connected to the inverter and generates a driving force for the electrified vehicle. The current of the electrical storage device is controlled by controlling switching of the inverter. Heat is thus generated from the electrical storage device due to power loss in the internal resistance of the electrical storage device.

### SUMMARY

A thermal management system that is mounted on an electrical apparatus such as an electrified vehicle includes a plurality of flow paths through which a heat medium flows, an electrical storage device, a drive device (motor and inverter), a radiator, a chiller device, and a switching device (e.g., a switching valve). The electrical storage device, the drive device, the radiator, and the chiller device are provided in different flow paths. The switching device switches the connection state among the flow paths.

If the switching device is not switched properly, heat from the electrical storage device may be taken by the heat medium in a different flow path. In addition, in an electrified vehicle, there is a demand to effectively use heat generated by the drive device.

The present disclosure provides a thermal management system that allows effective use of heat generated by a drive device of an electrical apparatus while reducing or eliminating the possibility of heat being taken from an electrical storage device.

A thermal management system according to a first aspect of the present disclosure is mounted on an electrical apparatus. The thermal management system includes: a first flow path, a second flow path, a third flow path, and a fourth flow path configured such that a heat medium flows through the first flow path, the second flow path, the third flow path, and the fourth flow path; an electrical storage device configured to exchange heat with the heat medium in the first flow path; a drive device configured to exchange heat with the heat medium in the second flow path and configured to generate a driving force; a radiator located in the third flow path; a chiller device located in the fourth flow path; and a switching device configured to switch a connection state among the first flow path, the second flow path, the third flow path, and the fourth flow path. The switching device is configured to cause a switching circuit to be formed. The switching circuit is a circuit in which the first flow path is disconnected from and independent of the second flow path, the third flow path, and the fourth flow path, the second flow path is connected to the fourth flow path, and the third flow path is disconnected from and independent of the second flow path and the fourth flow path.

With the above configuration, the first flow path is independent. This can reduce or prevent heat from the electrical storage device being taken by the heat medium in the second flow path, the third flow path, and the fourth flow path. Further, the third flow path is independent. This can reduce or prevent heat in the second flow path and the fourth flow path being dissipated from the radiator. Heat generated by the drive device can thus be stored in the heat medium in the second flow path and the fourth flow path. It is therefore possible to allow effective use of heat generated by the drive device of the electrified vehicle while reducing or preventing heat being taken from the electrical storage device.

In the thermal management system according to the first aspect of the present disclosure, the electrical apparatus may be an electrified vehicle.

In the thermal management system according to the first aspect of the present disclosure, the switching device may be configured to cause the switching circuit to be formed while heating of the electrical storage device is performed by causing a current to flow through the electrical storage device.

With the above configuration, the heating (self-heating) of the electrical storage device is performed while the first flow path is disconnected from the second flow path, the third flow path, and the fourth flow path. This reduces or prevents heat generated by the electrical storage device due to the self-heating from being transferred to the second flow path, the third flow path, or the fourth flow path via the heat medium. As a result, heat being taken from the electrical storage device during the heating control can be reduced or prevented. Therefore, the heating control can be effectively performed.

In the thermal management system according to the first aspect of the present disclosure, the electrical storage device may be heated after a traveling system of the electrified vehicle is activated.

In the thermal management system according to the first aspect of the present disclosure, the electrical storage device may be configured such that external charging is performed. The external charging may be charging of the electrical storage device with charging power supplied from charging equipment external to the electrified vehicle. The electrical storage device may be heated to cause a temperature of the electrical storage device to be a predetermined temperature or higher at start of the external charging. The phrase “at start of the external charging” may be a timing when the charging power begins to be supplied to the electrical storage device.

The thermal management system according to the first aspect of the present disclosure may further include a heating circuit configured to exchange heat via the chiller device and heat a vehicle cabin of the electrified vehicle. In a case where heating of the vehicle cabin is requested, heat from the drive device may be supplied to the heating circuit via the chiller device by driving the heating circuit with the switching circuit provided.

With the above configuration, heat from the drive device (heat stored in the heat medium in the second flow path and the fourth flow path) is supplied to the heating circuit via the chiller device in response to a request. The heat can thus be used for heating the vehicle cabin.

The thermal management system according to the first aspect of the present disclosure may further include: a first temperature sensor configured to detect a temperature of the electrical storage device; and a second temperature sensor configured to detect a temperature of the heat medium flowing through the second flow path and the fourth flow path. The switching circuit may be switched to connect the first flow path to the second flow path and the fourth flow path in response to a detected value from the second temperature sensor exceeding a detected value from the first temperature sensor during the heating of the electrical storage device with the switching circuit provided.

After the measured value from the second temperature sensor exceeds the measured value from the first temperature sensor, the temperature of the heat medium in the second flow path and the fourth flow path is higher than the temperature of the electrical storage device. With the above configuration, heat stored in the heat medium in the second flow path and the fourth flow path is transferred to the electrical storage device to heat the electrical storage device. As a result, the heating of the electrical storage device can further be facilitated.

In the thermal management system according to the first aspect of the present disclosure, the switching circuit may be switched to connect the third flow path to the second flow path and the fourth flow path in response to frost being detected on the radiator while the switching circuit is provided.

With the above configuration, heat stored in the heat medium in the second flow path and the fourth flow path due to heat generation of the drive device is transferred to the radiator to heat the radiator. The heat can thus be used for defrosting the radiator.

The thermal management system according to the first aspect of the present disclosure may further include a control device configured to control the switching device.

According to the present disclosure, it is possible to allow effective use of heat generated by the drive device of the electrical apparatus while reducing or preventing heat being taken from the electrical storage device.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows an electrified vehicle equipped with a thermal management system according to the present disclosure;

FIG. 2 shows an example of the overall configuration of a thermal management system according to a first embodiment of the present disclosure;

FIG. 3 shows an example of a specific configuration of a thermal management circuit according to the first embodiment;

FIG. 4 is a conceptual diagram showing an overview of a reference communication pattern of the thermal management circuit that is formed by controlling six-way valves;

FIG. 5 is a flowchart illustrating a process that is performed by an electronic control unit (ECU) according to the first embodiment;

FIG. 6 is a flowchart illustrating a process that is performed by the ECU according a first modification of the first embodiment;

FIG. 7 is a conceptual diagram showing an overview of a first communication pattern;

FIG. 8 is a flowchart illustrating a process that is performed by the ECU according a second modification of the first embodiment;

FIG. 9 is a conceptual diagram showing an overview of a second communication pattern;

FIG. 10 is a flowchart illustrating a process that is performed by the ECU according a third modification of the first embodiment;

FIG. 11 illustrates another example of the reference communication pattern of the thermal management circuit;

FIG. 12 illustrates still another example of the reference communication pattern of the thermal management circuit;

FIG. 13 illustrates the overall configuration of a thermal management system according to a fifth modification;

FIG. 14 shows an example of a specific configuration of a thermal management circuit according to the fifth modification;

FIG. 15A is a conceptual diagram showing an overview of a reference communication pattern according to the fifth modification;

FIG. 15B is a conceptual diagram showing an overview of a reference communication pattern according to the fifth modification;

FIG. 16 shows an example of the overall configuration of a thermal management system according to a second embodiment;

FIG. 17 shows an example of the configuration of a thermal management circuit according to the second embodiment;

FIG. 18 is a conceptual diagram showing an overview of a reference communication pattern formed by six-way valves;

FIG. 19 shows an example of the overall configuration of a thermal management system according to a third embodiment;

FIG. 20 shows an example of a specific configuration of a thermal management circuit according to the third embodiment;

FIG. 21A is a conceptual diagram showing an overview of a reference communication pattern of the thermal management circuit that is formed by controlling a ten-way valve;

FIG. 21B is a conceptual diagram showing an overview of a reference communication pattern of the thermal management circuit that is formed by controlling a ten-way valve;

FIG. 22 is a flowchart illustrating a process that is performed by the ECU according a modification; and

FIG. 23 shows a circuit configuration including a battery, a converter, an inverter, and a motor.

### DETAILED DESCRIPTION OF EMBODIMENTS

Embodiments of the present disclosure will be described in detail below with reference to the drawings. The same or corresponding parts are denoted by the same signs throughout the drawings, and description thereof will not be repeated.

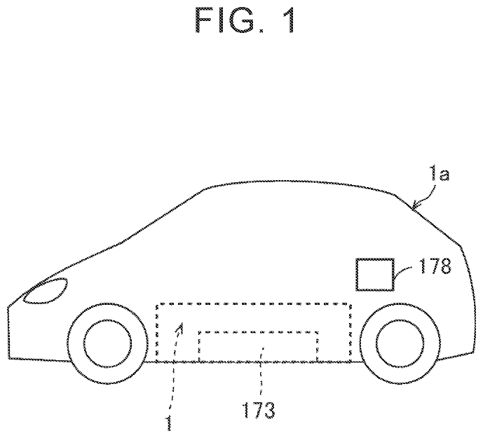

FIG. 1 shows an electrified vehicle equipped with a thermal management system according to the present disclosure. Referring to FIG. 1, an electrified vehicle 1a is a battery electric vehicle (BEV), and includes a battery 173 and an inlet 178. The battery 173 stores electric power for traveling of the electrified vehicle 1a. The battery 173 is configured to be charged externally with charging power supplied through the inlet 178 from charging equipment (not shown) external to the electrified vehicle 1a. The electrified vehicle 1a is an example of the “electrical apparatus” of the present disclosure.

### First Embodiment

### Overall Configuration

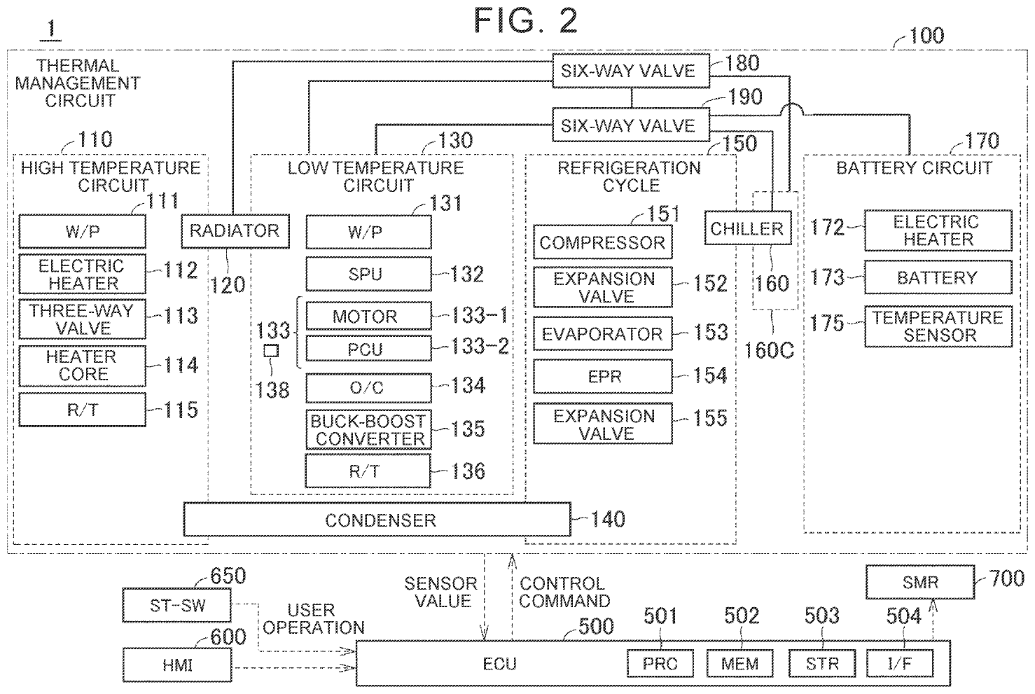

FIG. 2 shows an example of the overall configuration of a thermal management system 1 according to a first embodiment of the present disclosure. The thermal management system 1 includes a thermal management circuit 100, an electronic control unit (ECU) 500, a human machine interface (HMI) 600, a start switch (ST-SW) 650, and a system main relay (SMR) 700.

The thermal management circuit 100 is configured so that a heat medium flows therethrough. The thermal management circuit 100 includes a high temperature circuit 110, a radiator 120, a low temperature circuit 130, a condenser 140, a refrigeration cycle 150, a chiller circuit 160C (chiller 160), a battery circuit 170, a six-way valve 180, and a six-way valve 190. The six-way valves 180, 190 are an example of the “switching device” of the present disclosure. The chiller 160 is an example of the “chiller device” of the present disclosure.

The high temperature circuit 110 is an example of the “heater circuit” of the present disclosure, and includes a water pump (W/P) 111, an electric heater 112, a three-way valve 113, a heater core 114, and a reservoir tank (R/T) 115.

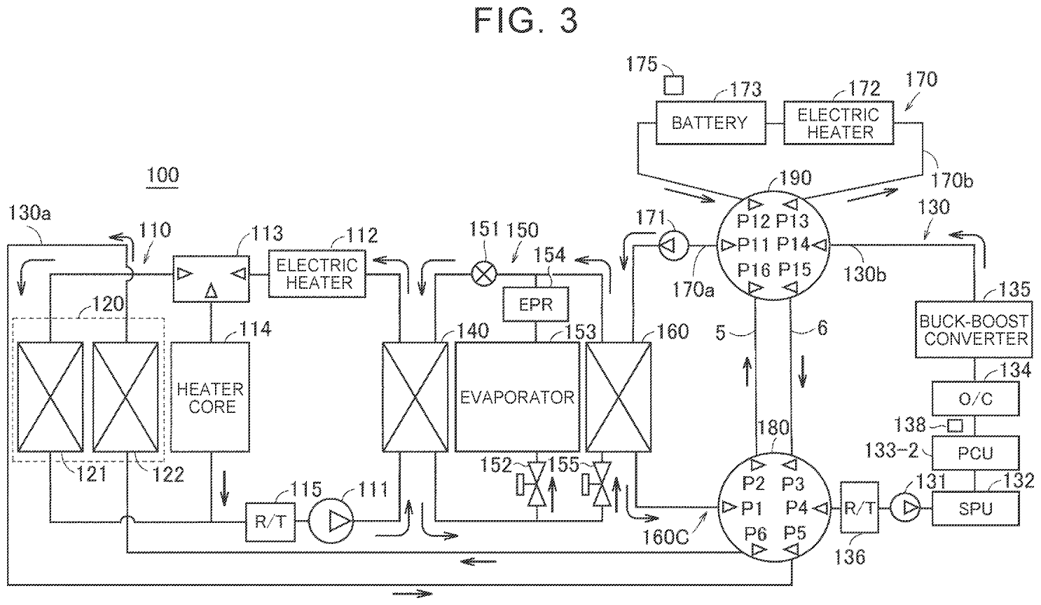

The radiator 120 is connected to (i.e., shared by) both the high temperature circuit 110 and the low temperature circuit 130. The radiator 120 includes a high temperature (HT) radiator 121 and a low temperature (LT) radiator 122 (see FIG. 3). The low temperature radiator 122 exchanges heat between the heat medium flowing in the low temperature circuit 130 and outside air. The low temperature radiator 122 is an example of the “radiator” of the present disclosure.

The low temperature circuit 130 includes a water pump 131, a smart power unit (SPU) 132, a motor 133-1, a power control unit (PCU) 133-2, an oil cooler (O/C) 134, a buck-boost converter 135, a reservoir tank 136, and a temperature sensor 138. The PCU 133-2 includes a converter and an inverter. The motor 133-1 and the PCU 133-2 are also referred to as “transaxle 133.” The transaxle 133 is configured to be connected to the battery 173, and is configured to generate a driving force for the electrified vehicle 1a with electric power supplied from the battery 173. The transaxle 133 is an example of the “drive device” of the present disclosure. The temperature sensor 138 is an example of the “second temperature sensor” of the present disclosure.

The condenser 140 is connected to both the high temperature circuit 110 and the refrigeration cycle 150.

The refrigeration cycle 150 includes a compressor 151, an expansion valve 152, an evaporator 153, an evaporative pressure regulator (EPR) 154, and an expansion valve 155.

The chiller circuit 160C includes the chiller 160 and a water pump 171 (see FIG. 3). The chiller 160 is provided in the chiller circuit 160C, and is connected to both the refrigeration cycle 150 and the chiller circuit 160C. The chiller 160 exchanges heat between the heat medium flowing in the battery circuit 170 and the heat medium circulating in the refrigeration cycle 150.

The battery circuit 170 includes an electric heater 172, a battery 173, and a temperature sensor 175. The battery 173 is an example of the “electrical storage device” of the present disclosure. The temperature sensor 175 is an example of the “first temperature sensor” of the present disclosure.

The six-way valve 180 is connected to the radiator 120, the low temperature circuit 130, the chiller circuit 160C, and the six-way valve 190. The six-way valve 190 is connected to the low temperature circuit 130, the chiller circuit 160C, the battery circuit 170, and the six-way valve 180. The configuration of the thermal management circuit 100 will be described in detail later with reference to FIG. 3.

The ECU 500 controls the thermal management circuit 100. The ECU 500 includes a processor 501, a memory 502, a storage 503, and an interface 504.

The processor 501 is, for example, a central processing unit (CPU). The memory 502 is, for example, a random access memory (RAM). The storage 503 is a rewritable nonvolatile memory such as a hard disk drive (HDD) or a solid state drive (SSD). The storage 503 stores system programs including an operating system (OS), and control programs including computer-readable codes that are necessary for control calculations. The processor 501 implements various processes by reading the system programs and the control programs, loading them into the memory 502, and executing them. The interface 504 allows communication between the ECU 500 and components of the thermal management circuit 100.

The ECU 500 generates control commands based on sensor values acquired from various sensors (e.g., battery temperature sensor 175) included in the thermal management circuit 100, user operations received by the HMI 600 or the start switch 650, etc. The ECU 500 outputs the generated control commands to various circuits (various devices) of the electrified vehicle 1a, such as the thermal management circuit 100.

The ECU 500 is configured to control the current of the battery 173 (perform charge control or discharge control) by controlling switching of the inverter of the PCU 133-2. The ECU 500 thus controls heat that is generated due to power loss in the internal resistance of the battery 173. As a result, the ECU 500 can perform heating control for increasing the temperature of the battery 173 (perform heating of the battery 173) by causing a current to flow through the battery 173 (by charging or discharging) (self-heating of the battery 173). In this case, the operation of the electric heater 172 is not necessarily required to heat the battery 173. For example, the ECU 500 performs the heating control after a traveling system (described later) of the electrified vehicle 1a is activated. The ECU 500 is also configured to control the six-way valves 180, 190, control on and off of the SMR 700, and perform an external charging control for controlling external charging.

The HMI 600 receives user operations for controlling the thermal management system 1. The user operations include a heating request operation for heating the vehicle cabin of the electrified vehicle 1a. Heating the vehicle cabin also includes pre-heating that starts at the time scheduled by a user. The user operation may be a heating stop request operation for requesting the stop of heating of the vehicle cabin. The HMI 600 outputs signals indicating user operations to the ECU 500.

The SMR 700 is located between the transaxle 133 (specifically, the PCU 133-2) and the battery 173.

The start switch 650 is operated by the user to activate the traveling system of the electrified vehicle 1a. The traveling system is composed of the transaxle 133, the battery 173, and the SMR 700. When the start switch 650 is operated, the ECU 500 turns on the SMR 700 (switches the SMR 700 from the open state to the closed state). The transaxle 133 is thus connected to the battery 173 via the SMR 700. As a result, the traveling system is activated. As described above, activating the traveling system is equivalent to turning on the SMR 700.

### Configuration of Thermal Management Circuit

FIG. 3 shows an example of a specific configuration of the thermal management circuit 100 according to the first embodiment. The high temperature circuit 110 is formed so that it can exchange heat with the heat medium in a flow path 130b (described later) via the condenser 140, the refrigeration cycle 150, the chiller 160, and the six-way valves 180, 190, and is configured to heat the vehicle cabin of the electrified vehicle 1a. The heat medium (usually hot water) circulating in the high temperature circuit 110 flows through either or both of a first path and a second path. The first path is a path of “water pump 111-condenser 140-electric heater 112-three-way valve 113-heater core 114-reservoir tank 115-water pump 111.” The second path is a path of “water pump 111-condenser 140-electric heater 112-three-way valve 113-high temperature radiator 121-reservoir tank 115-water pump 111.”

The heat medium (coolant) circulating in the low temperature circuit 130 flows through the following path: “six-way valve 180-reservoir tank 136-water pump 131-SPU 132-PCU 133-2 (transaxle 133)-oil cooler 134-buck-boost converter 135-six-way valve 190.”

The water pump 131 circulates the heat medium in the low temperature circuit 130 according to a control command from the ECU 500. The SPU 132 controls charge and discharge of the battery 173 according to a control command from the ECU 500. The PCU 133-2 converts direct current (DC) power supplied from the battery 173 to alternating current (AC) power to supply the AC power to the motor 133-1 according to a control command from the ECU 500. The oil cooler 134 circulates lubricating oil for the motor 133-1 by using an electrical oil pump (EOP) (not shown). The oil cooler 134 cools the motor 133-1 (transaxle 133) through heat exchange between the heat medium circulating in the low temperature circuit 130 and the lubricating oil for the motor 133-1.

The temperature sensor 138 is located downstream of the transaxle 133, and detects the temperature of the heat medium in the flow path 130b. The SPU 132, the PCU 133-2, the oil cooler 134, and the buck-boost converter 135 are cooled by the heat medium circulating in the low temperature circuit 130.

The reservoir tank 136 stores part of the heat medium flowing in the low temperature circuit 130 to maintain the pressure and amount of heat medium in the low temperature circuit 130. Each of the six-way valves 180, 190 switches the path of the heat medium in the high temperature circuit 110, the low temperature circuit 130, the battery circuit 170, and the chiller circuit 160C according to a control command from the ECU 500. The low temperature radiator 122 is disposed near the high temperature radiator 121, and exchanges heat with the high temperature radiator 121.

The heat medium (gas-phase refrigerant or liquid-phase refrigerant) circulating in the refrigeration cycle 150 flows through either or both of a first path and a second path. The first path is a path of “compressor 151-condenser 140-expansion valve 152-evaporator 153-EPR 154-compressor 151.” The second path is a path of “compressor 151-condenser 140-expansion valve 155-chiller 160-compressor 151.”

The heat medium (coolant) circulating in the battery circuit 170 flows through the following path: “six-way valve 190-electric heater 172-battery 173-six-way valve 190.” The electric heater 172 heats the heat medium in the battery circuit 170 according to a control command from the ECU 500. The battery 173 can be heated by the heat medium heated by using the electric heater 172. The temperature sensor 175 detects the temperature of the battery 173.

The heat medium (coolant) circulating in the chiller circuit 160C flows through the following path: “six-way valve 190-water pump 171-chiller 160-six-way valve 180.”

The water pump 171 circulates the heat medium in the chiller circuit 160C according to a control command from the ECU 500. The chiller 160 cools the heat medium in the chiller circuit 160C through heat exchange between the heat medium circulating in the refrigeration cycle 150 and the heat medium circulating in the chiller circuit 160C. Bypass paths 5, 6 interconnect the six-way valves 180, 190.

The six-way valve 180 includes ports P1 to P6. The port P1 is an inlet port into which the heat medium flows from the chiller 160 of the chiller circuit 160C. The port P2 is an outlet port from which the heat medium flows toward the bypass path 5, and is connected to a port P16 (described later) through the bypass path 5. The port P3 is an inlet port into which the heat medium flows from the bypass path 6, and is connected to a port P15 (described later) through the bypass path 6. The port P4 is an outlet port from which the heat medium flows toward the SPU 132, the PCU 133-2, the oil cooler 134, and the buck-boost converter 135 of the low temperature circuit 130. The port P5 is an inlet port into which the heat medium flows from the low temperature radiator 122. The port P6 is an outlet port from which the heat medium flows toward the low temperature radiator 122.

The six-way valve 190 includes ports P11 to P16. The port P11 is an outlet port from which the heat medium flows toward the chiller 160 of the chiller circuit 160C. The port P12 is an inlet port into which the heat medium flows from the electric heater 172 and the battery 173 of the battery circuit 170. The port P13 is an outlet port from which the heat medium flows toward the electric heater 172 and the battery 173 of the battery circuit 170. The port P14 is an inlet port into which the heat medium flows from the SPU 132, the PCU 133-2, the oil cooler 134, and the buck-boost converter 135 of the low temperature circuit 130. The port P15 is an outlet port from which the heat medium flows toward the bypass path 6. The port P16 is an inlet port into which the heat medium flows from the bypass path 5.

The six-way valves 180, 190 are configured to switch the connection state among a flow path 130a, the flow path 130b, a flow path 170a, and a flow path 170b (all of which will be described in detail later) according to a command from the ECU 500.

The battery 173 is provided in the flow path 170b of the battery circuit 170. The battery 173 exchanges heat with the heat medium in the flow path 170b. The flow path 170b is in thermal contact with the battery 173. The flow path 170b is a flow path connecting the port P12 and the port P13 of the six-way valve 190. The heat medium can flow through the flow path 170b. The flow path 170b is an example of the “first flow path” of the present disclosure.

The low temperature radiator 122 is provided in the flow path 130a. The flow path 130a is a flow path connecting the port P5 and the port P6 of the six-way valve 180. The heat medium can flow through the flow path 130a. The flow path 130a is an example of the “third flow path” of the present disclosure.

The water pump 131, the SPU 132, the PCU 133-2 (transaxle 133), the oil cooler 134, the buck-boost converter 135, and the reservoir tank 136 are provided in the flow path 130b of the low temperature circuit 130. The PCU 133-2 (transaxle 133) etc. exchange heat with the heat medium in the flow path 130b. The flow path 130b is in thermal contact with the SPU 132, the PCU 133-2 (transaxle 133), the oil cooler 134, and the buck-boost converter 135. The flow path 130b is a flow path connecting the port P4 of the six-way valve 180 and the port P14 of the six-way valve 190. The heat medium can flow through the flow path 130b. The flow path 130b is an example of the “second flow path” of the present disclosure.

The chiller 160 is provided in the flow path 170a of the chiller circuit 160C. The flow path 170a is a flow path connecting the port P1 of the six-way valve 180 and the port P11 of the six-way valve 190. The heat medium can flow through the flow path 170a. The flow path 170a is an example of the “fourth flow path” of the present disclosure.

### Communication Patterns

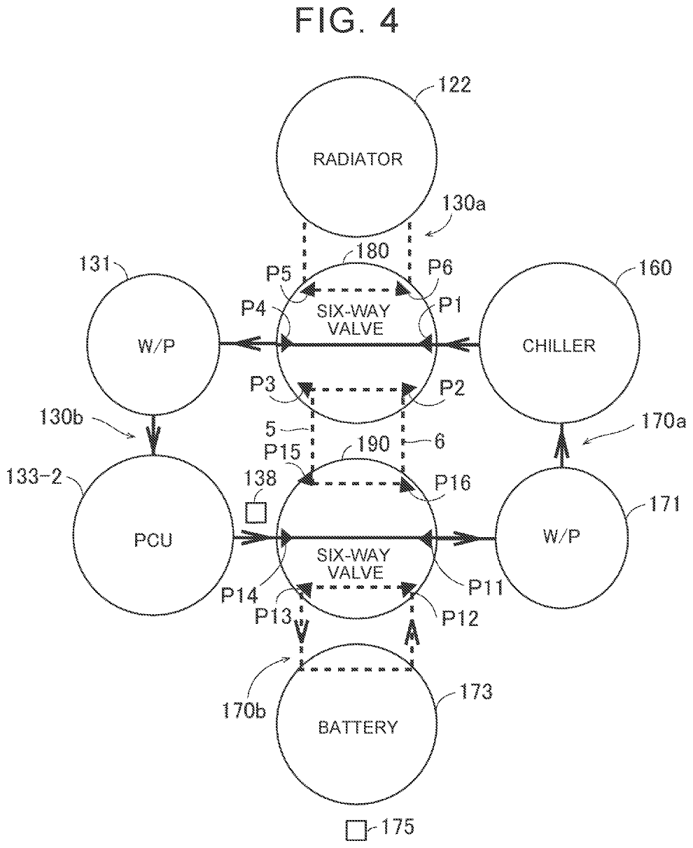

FIG. 4 is a conceptual diagram showing an overview of a predetermined communication pattern (hereinafter sometimes referred to as “reference communication pattern”) of the thermal management circuit 100 that is formed by controlling the six-way valves 180, 190. The reference communication pattern is an example of the “switching circuit” of the present disclosure.

Since the electrified vehicle 1a is not equipped with an engine, it is not possible to use engine waste heat to heat components of the electrified vehicle 1a that are to be heated. Therefore, it is sometimes important to effectively use the heat generated by the transaxle 133. Moreover, when the heat generated by the battery 173 is transferred to components such as the low temperature radiator 122 via the heat medium during the heating control of the battery 173 performed by the ECU 500, the heat may be taken from the battery 173 and the heating control may not be effectively performed. It is therefore desired to efficiently perform the heating control of the battery 173.

In the first embodiment, when performing the heating control of the battery 173, the ECU 500 controls the six-way valves 180, 190 to form the reference communication pattern (FIG. 4). In the reference communication pattern, the six-way valve 180 forms a path communicating between the port P1 and the port P4, a path communicating between the port P2 and the port P3, and a path communicating between the port P5 and the port P6 (flow path 130a).

In the reference communication pattern, the six-way valve 190 forms a path communicating between the port P11 and the port P14, a path communicating between the port P12 and the port P13 (flow path 170b), and a path communicating between the port P15 and the port P16.

As a result, the flow path 170b is disconnected from and independent of the flow paths 130a, 130b, and 170a. The flow path 130b is connected to the flow path 170a. The flow path 130a is disconnected from and independent of the flow paths 130b and 170a.

In the reference communication pattern, the flow path 170b is independent. This can reduce or prevent the heat of the battery 173 being taken by the heat medium in the flow path 130a, the flow path 130b, and the flow path 170a. As a result, the heating control can be effectively performed. Further, the flow path 130a is independent. This can reduce or prevent the heat in the flow path 130b and the flow path 170a being dissipated from the low temperature radiator 122. The heat generated by the transaxle 133 (PCU 133-2) can thus be stored in the heat medium in the flow path 130b and the flow path 170a. Therefore, it is possible to allow effective use of heat generated by the transaxle 133 while reducing or preventing heat being taken from the battery 173.

In this example, the ECU 500 forms the reference communication pattern when performing the heating control of the battery 173. With this configuration, the heating control (self-heating) is performed while the flow path 170b is disconnected from the flow path 130a, the flow path 130b, and the flow path 170a. This reduces or prevent heat generated by the battery 173 due to the self-heating being transferred to the flow path 130a, the flow path 130b, or the flow path 170a via the heat medium. As a result, the heating control can be effectively performed.

### Method for Controlling Thermal Management Circuit

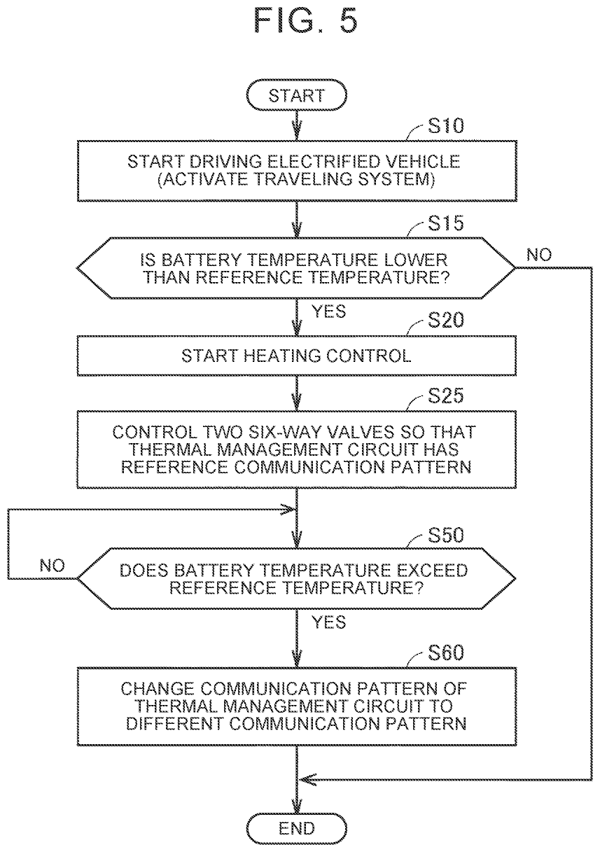

FIG. 5 is a flowchart illustrating a process that is performed by the ECU 500 according to the first embodiment. Hereinafter, the term “step” is abbreviated as “S.”

Referring to FIG. 5, the ECU 500 starts driving the electrified vehicle 1a (activates the traveling system) (S10). Specifically, the ECU 500 turns on the SMR 700 in response to an operation (pressing) of the start switch 650.

The ECU 500 determines whether the temperature of the battery 173 detected by the temperature sensor 175 is lower than a predetermined reference temperature (e.g., 10° C.) (S15). When the temperature of the battery 173 is equal to or higher than the reference temperature (No in S15), the process ends. When the temperature of the battery 173 is lower than the reference temperature (Yes in S15), the process proceeds to step S20.

The ECU 500 starts the heating control by performing charge control or discharge control of the battery 173 (S20). The ECU 500 controls the six-way valves 180, 190 so that the thermal management circuit 100 has the reference communication pattern (FIG. 4) (S25). The ECU 500 may perform S20 and S25 simultaneously.

The ECU 500 determines whether the temperature of the battery 173 exceeds the reference temperature (S50). When the temperature of the battery 173 is equal to or lower than the reference temperature (No in S50), the determination process of S50 is repeated until the temperature of the battery 173 exceeds the reference temperature. When the temperature of the battery 173 exceeds the reference temperature (Yes in S50), the heating control of the battery 173 by the ECU 500 ends, and the process proceeds to S60.

The ECU 500 controls the six-way valves 180, 190 to change the communication pattern of the thermal management circuit 100 from the reference communication pattern (FIG. 4) to a different communication pattern (e.g., a communication pattern suitable for traveling of the electrified vehicle 1a) (S60). The process then ends.

As described above, in the first embodiment, it is possible to allow effective use of heat generated by the transaxle 133 while reducing or preventing heat being taken from the battery 173 during the heating control.

### First Modification of First Embodiment

Referring back to FIGS. 3 and 4, the process that is performed by the ECU 500 when heating of the vehicle cabin is requested while the reference communication pattern is formed (e.g., when the heating request operation described above is performed) will be described. In this case, the ECU 500 supplies heat from the transaxle 133 to the high temperature circuit 110 via the six-way valves 180, 190, the chiller 160, the refrigeration cycle 150, and the condenser 140 by driving the high temperature circuit 110 (specifically, the water pump 111 and optionally the electric heater 112) with the reference communication pattern formed.

With this configuration, the heat from the transaxle 133 (heat stored in the heat medium in the flow paths 130b, 170b) is supplied to the heater core 114 via the chiller 160, the refrigeration cycle 150, and the condenser 140 in response to a heating request. Not only the heat from the electric heater 112 but also the heat from the transaxle 133 can thus be used to heat the vehicle cabin. As a result, the amount of heat that needs to be generated by the electric heater 112 to heat the vehicle cabin can be reduced (burden on the electric heater 112 can be reduced).

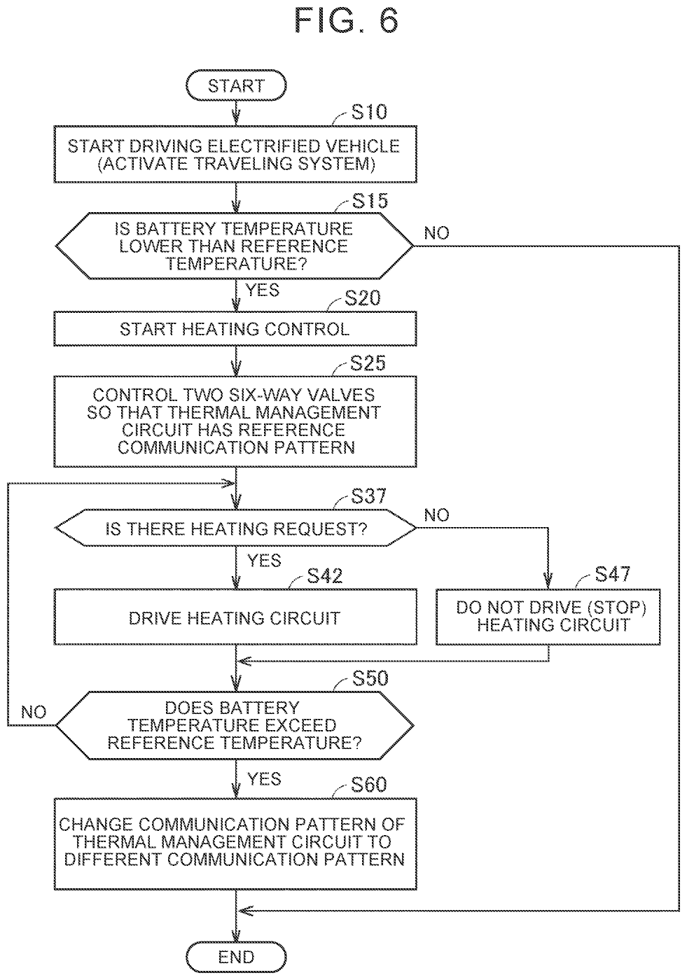

FIG. 6 is a flowchart illustrating a process that is performed by the ECU 500 according a first modification of the first embodiment. This flowchart is different from the flowchart of the first embodiment (FIG. 5) in that S37, S42, and S47 are added. This flowchart is otherwise the same as the flowchart of the first embodiment.

Referring to FIG. 6, in S37 after S25, the ECU 500 determines whether a heating request operation has been performed (whether there is a heating request). When there is a heating request (Yes in S37), the ECU 500 drives a heating circuit (S42). When there is no heating request (No in S37), the ECU 500 does not drive the heating circuit (S47). For example, S47 is a step of stopping the heating circuit when a request is made to stop the heating while the heating circuit is being driven. After S42 or S47, the process proceeds to S50.

According to the first modification of the first embodiment, the heat from the transaxle 133 can be stored in the heat medium in the flow path 130b, and the stored heat can be used to heat the vehicle cabin.

### Second Modification of First Embodiment

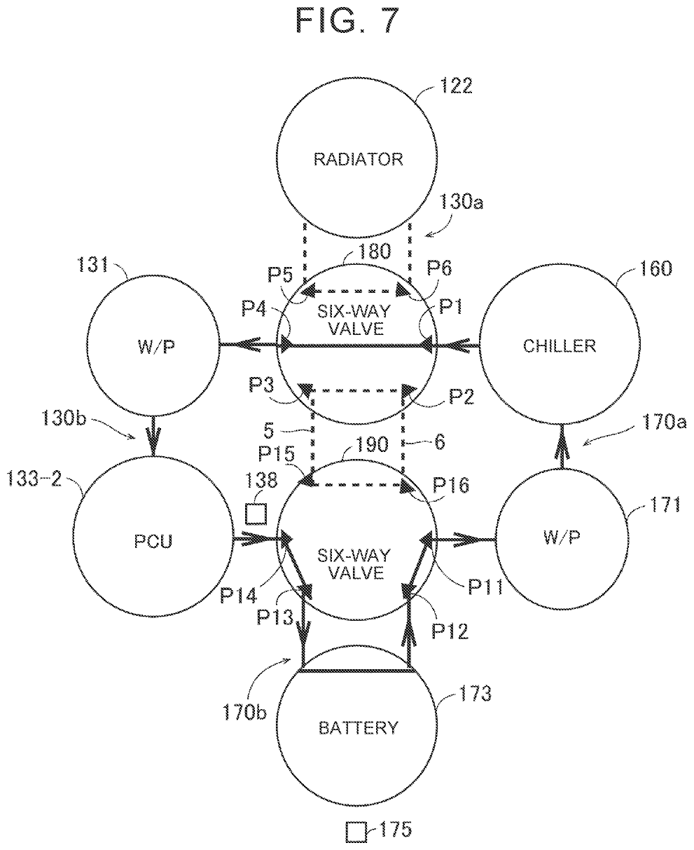

Referring back to FIGS. 3 and 4, when the detected value from the temperature sensor 138 exceeds the detected value from the temperature sensor 175 during the heating control of the battery 173 with the reference communication pattern formed, the ECU 500 may control (switch) the six-way valves 180, 190 so that the flow path 170b is connected to the flow path 130b. As a result, the communication pattern of the thermal management circuit 100 changes from the reference communication pattern (FIG. 4) to a first communication pattern (FIG. 7). While the reference communication pattern is formed, the temperature sensor 138 detects the temperature of the heat medium flowing through the flow path 130b and the flow path 170a.

After the detected value from the temperature sensor 138 exceeds the detected value from the temperature sensor 175, the temperature of the heat medium in the flow paths 130b, 170a is higher than the temperature of the battery 173. In the first communication pattern, the heat stored in the heat medium in the flow paths 130b, 170a is transferred to the battery 173. As a result, the battery 173 is heated by the heat stored in the heat medium in the flow paths 130b, 170a (heat generated from the transaxle 133) in addition to the heat generated due to the internal resistance of the battery 173 during the heating control of the battery 173. The heating of the battery 173 can thus be further facilitated (the temperature of the battery 173 can be made to exceed the reference temperature more quickly).

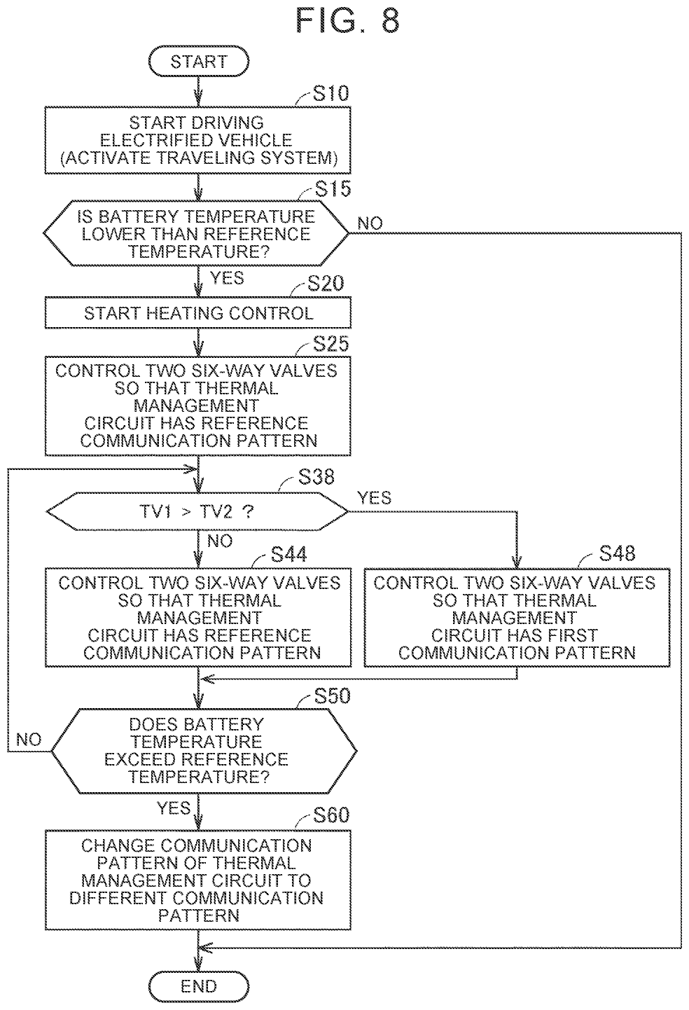

FIG. 8 is a flowchart illustrating a process that is performed by the ECU 500 according a second modification of the first embodiment. This flowchart is different from the flowchart of the first embodiment (FIG. 5) in that S38, S44, and S48 are added. This flowchart is otherwise the same as the flowchart of the first embodiment.

Referring to FIG. 8, after S25, the ECU 500 determines whether a detected value TV1 from the temperature sensor 138 is higher than a detected value TV2 from the temperature sensor 175 (S38). When the detected value TV1 is equal to or lower than the detected value TV2 (No in S38), the ECU 500 controls the six-way valves 180, 190 so that the thermal management circuit 100 has the reference communication pattern (FIG. 4) (S44). When the detected value TV1 is higher than the detected value TV2 (Yes in S38), the ECU 500 controls the six-way valves 180, 190 so that the thermal management circuit 100 has the first communication pattern (FIG. 7) (S48). For example, when the detected value TV1 exceeds the detected value TV2, the ECU 500 switches the six-way valves 180, 190 so that the communication pattern of the thermal management circuit 100 changes from the reference communication pattern to the first communication pattern. After S44 or S48, the process proceeds to S50.

According to the second modification of the first embodiment, heating of the battery 173 can be facilitated during the heating control of the battery 173.

### Third Modification of First Embodiment

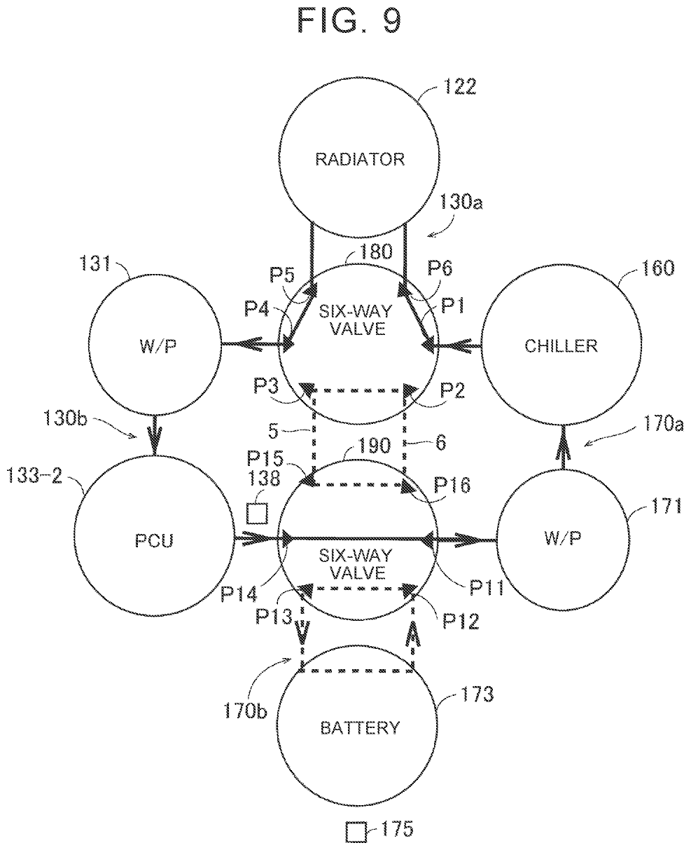

Referring back to FIG. 4, when frost on the low temperature radiator 122 is detected while the reference communication pattern is formed, the ECU 500 may control the six-way valves 180, 190 so that the flow path 130a is connected to the flow paths 130b, 170a. As a result, the communication pattern of the thermal management circuit 100 changes from the reference communication pattern (FIG. 4) to a second communication pattern (FIG. 9).

In the second communication pattern, heat stored in the heat medium in the flow paths 130b, 170a due to heat generation of the transaxle 133 is transferred to the low temperature radiator 122 to heat the low temperature radiator 122. As a result, the heat can be used for defrosting the low temperature radiator 122.

It is assumed that the ECU 500 detects frost on the low temperature radiator 122 based on satisfaction of a predetermined condition. The predetermined condition is, for example, that a detected value from a radiator temperature sensor (not shown) that detects the temperature of the heat medium in the flow path 130a is below a threshold value. The threshold value is determined as appropriate by an evaluation test conducted in advance, and is, for example, 0° C. The predetermined condition may further include a precondition that a detected value from an outside temperature sensor (not shown) that detects the temperature outside the electrified vehicle 1a is lower than the detected value from the radiator temperature sensor by a predetermined value. It is assumed that the radiator temperature sensor and the outside temperature sensor shall are included in the thermal management system. The threshold value and the predetermined value are stored in the storage 503 of the ECU 500. The ECU 500 may control the six-way valves 180, 190 as described above when the condition that the detected value from the temperature sensor 138 is higher than the detected value from the radiator temperature sensor is satisfied in addition to satisfaction of the predetermined condition.

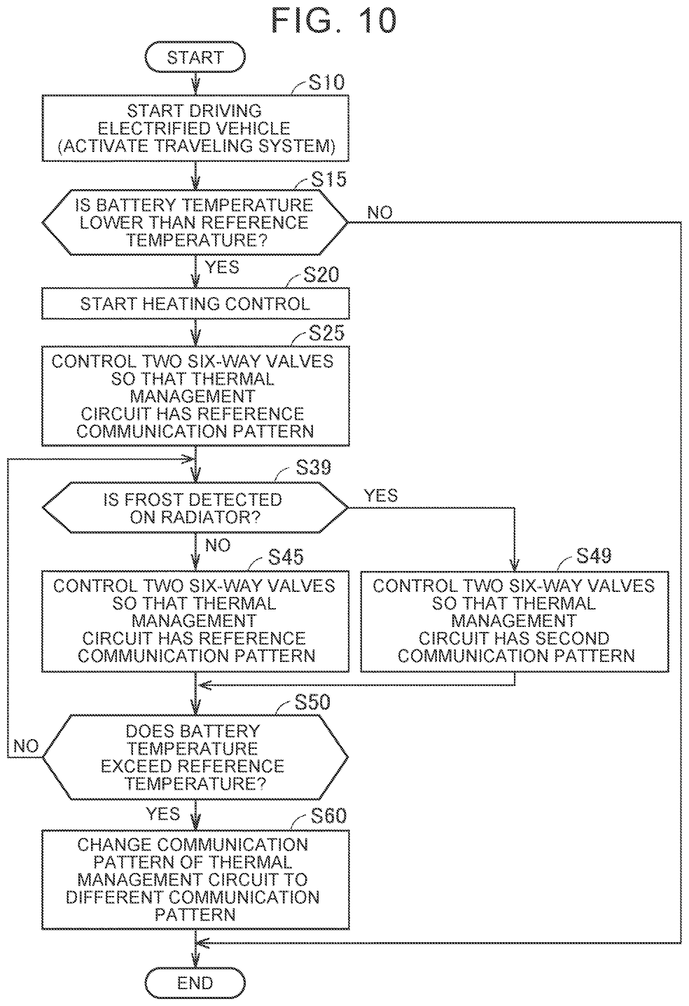

FIG. 10 is a flowchart illustrating a process that is performed by the ECU 500 according a third modification of the first embodiment. This flowchart is different from the flowchart of the first embodiment (FIG. 5) in that S39, S45, and S49 are added. This flowchart is otherwise the same as the flowchart of the first embodiment.

Referring to FIG. 10, after S25, the ECU 500 switches the process depending on whether frost is detected on the low temperature radiator 122 (S39). When frost is not detected (No in S39), the ECU 500 controls the six-way valves 180, 190 so that the thermal management circuit 100 has the reference communication pattern (FIG. 4) (S45). When frost is detected (Yes in S39), the ECU 500 controls the six-way valves 180, 190 so that the thermal management circuit 100 has the second communication pattern (FIG. 9) (S49). For example, when the reference communication pattern is formed immediately before S49, the ECU 500 switches the six-way valves 180, 190 so that the communication pattern of the thermal management circuit 100 changes from the reference communication pattern to the second communication pattern. After S45 or S49, the process proceeds to S50.

According to the third modification of the first embodiment, when frost is detected on the low temperature radiator 122, the low temperature radiator 122 is heated by using heat stored in the heat medium in the flow paths 130b, 170a. The heat can thus be used for defrosting the radiator.

### Fourth Modification of First Embodiment

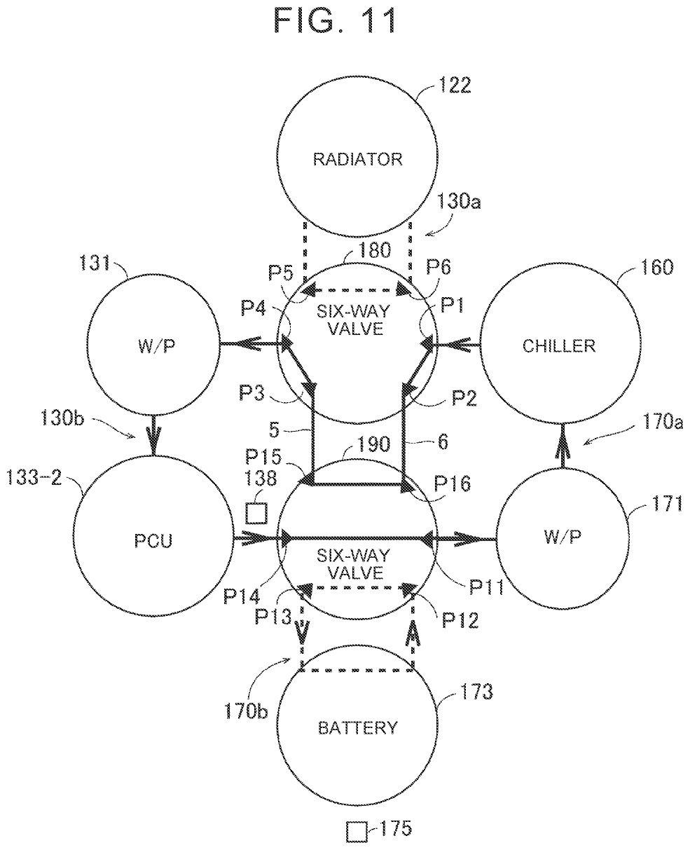

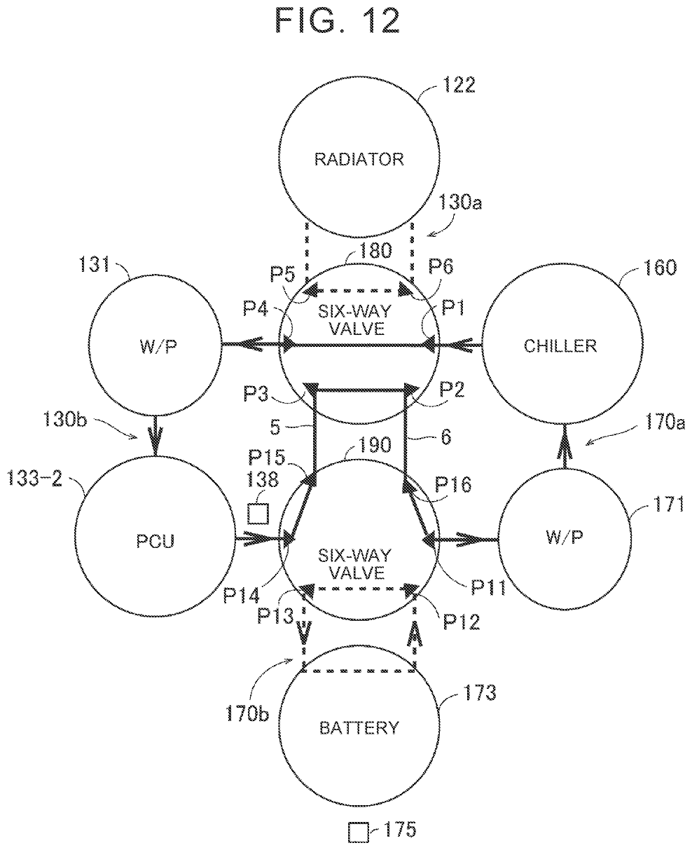

FIGS. 11 and 12 illustrate other examples of the reference communication pattern of the thermal management circuit 100. Referring to FIG. 11, the reference communication pattern is not limited to the pattern shown in FIG. 4 and may be different patterns as shown in FIGS. 11 and 12 as long as the flow path 170b is disconnected from and independent of the flow paths 130a, 130b, and 170a, the flow path 130b is connected to the flow path 170a, and the flow path 130a is disconnected from and independent of the flow paths 130b, 170a.

### Fifth Modification of First Embodiment

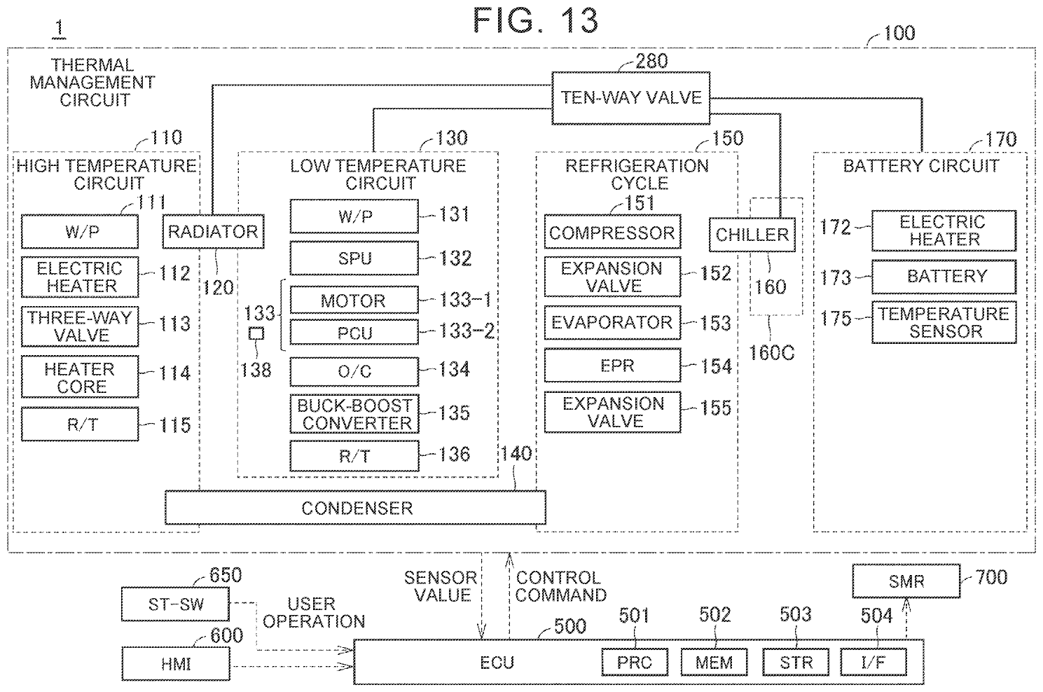

FIG. 13 illustrates the overall configuration of a thermal management system 1 according to a fifth modification. Referring to FIG. 13, in this example, the six-way valves 180, 190 (FIG. 2) are replaced with a ten-way valve 280. The ten-way valve 280 is connected to the radiator 120, the low temperature circuit 130, the chiller circuit 160C, and the battery circuit 170. The ten-way valve 280 is an example of the “switching device” of the present disclosure.

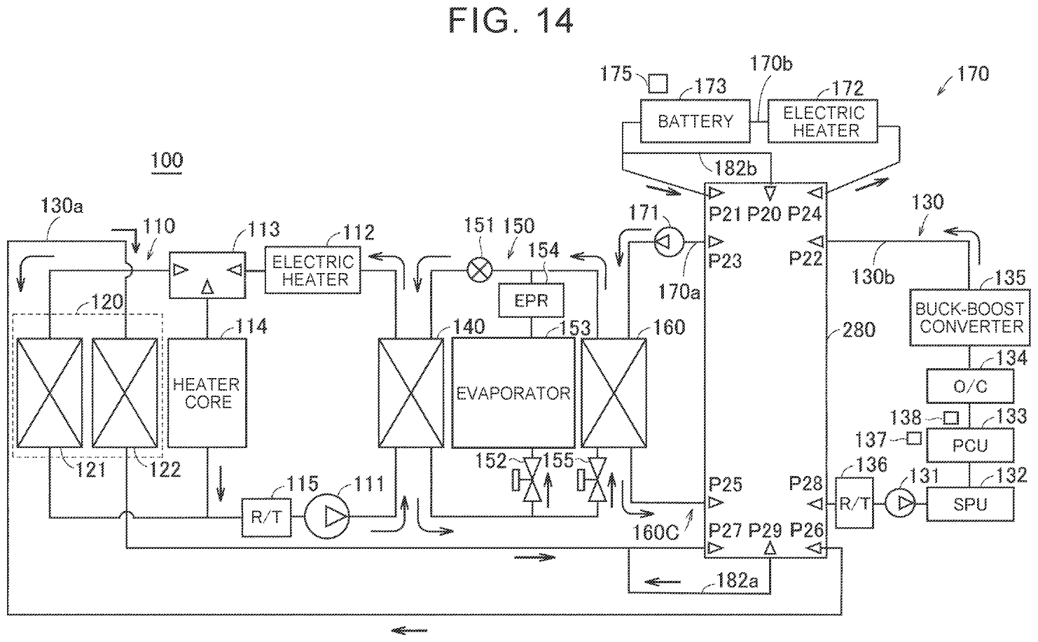

FIG. 14 shows an example of a specific configuration of a thermal management circuit 100 according to the fifth modification. Referring to FIG. 14, the ten-way valve 280 includes ports P20 to P29.

The port P20 is an outlet port from which the heat medium flows toward a bypass path 182b. The port P21 is an inlet port into which the heat medium flows from the battery 173 or the bypass path 182b. The port P22 is an inlet port into which the heat medium flows from the low temperature circuit 130. The port P23 is an outlet port from which the heat medium flows toward the chiller 160. The port P24 is an outlet port from which the heat medium flows toward the battery 173. The port P25 is an inlet port into which the heat medium flows from the chiller 160. The port P26 is an outlet port from which the heat medium flows toward the low temperature radiator 122. The port P27 is an inlet port into which the heat medium flows from the low temperature radiator 122 or a bypass path 182a. The port P28 is an outlet port from which the heat medium flows toward the SPU 132, the PCU 133-2, the oil cooler 134, and the buck-boost converter 135 of the low temperature circuit 130. The port P29 is an outlet port from which the heat medium flows toward the bypass path 182a.

The ten-way valve 280 is configured to switch the connection state among the flow path 130a, the flow path 130b, the flow path 170a, and the flow path 170b according to a command from the ECU 500.

The flow path 170b is a flow path connecting the ports P24, P21. The flow path 130b is a flow path connecting the ports P28, P22. The flow path 170a is a flow path connecting the ports P25, P23. The flow path 130a is a flow path connecting the ports P26, P27.

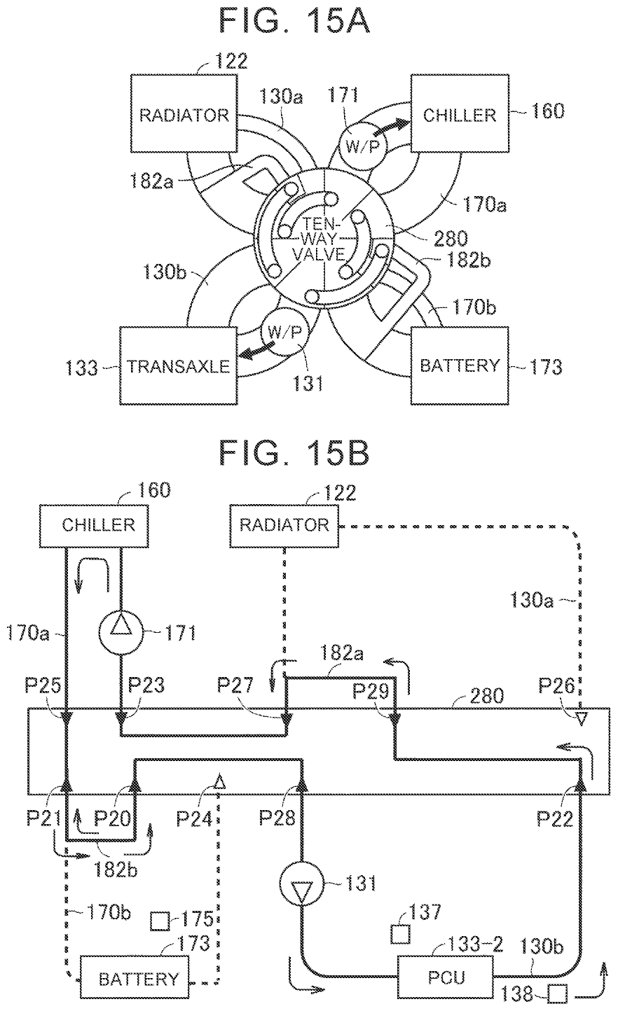

FIGS. 15A and 15B are conceptual diagrams showing an overview of a reference communication pattern according to the fifth modification. FIG. 15A schematically shows the relationship among the ten-way valve 280, the low temperature radiator 122, the transaxle 133, the chiller 160, and the battery 173. FIG. 15B illustrates in detail how the heat medium flows in the circuit shown in FIG. 15A. The ECU 500 forms the reference communication pattern (FIGS. 15A and 15B) when performing the heating control.

Similarly to the pattern of the first embodiment (FIG. 4), in this reference communication pattern, the flow path 170b is disconnected from and independent of the flow paths 130a, 130b, and 170a, the flow path 130b is connected to the flow path 170a, and the flow path 130a is disconnected from and independent of the flow paths 130b, 170a. As a result, the fifth modification also provides the same effects as those of the first embodiment.

### Second Embodiment

In the first embodiment, the switching device such as the six-way valve or the ten-way valve is used in the thermal management system 1 (thermal management circuit 100). However, the switching device may be used in a thermal management system different from the thermal management system 1. In a second embodiment, an example in which the switching device is the six-way valve will be described.

### Overall Configuration

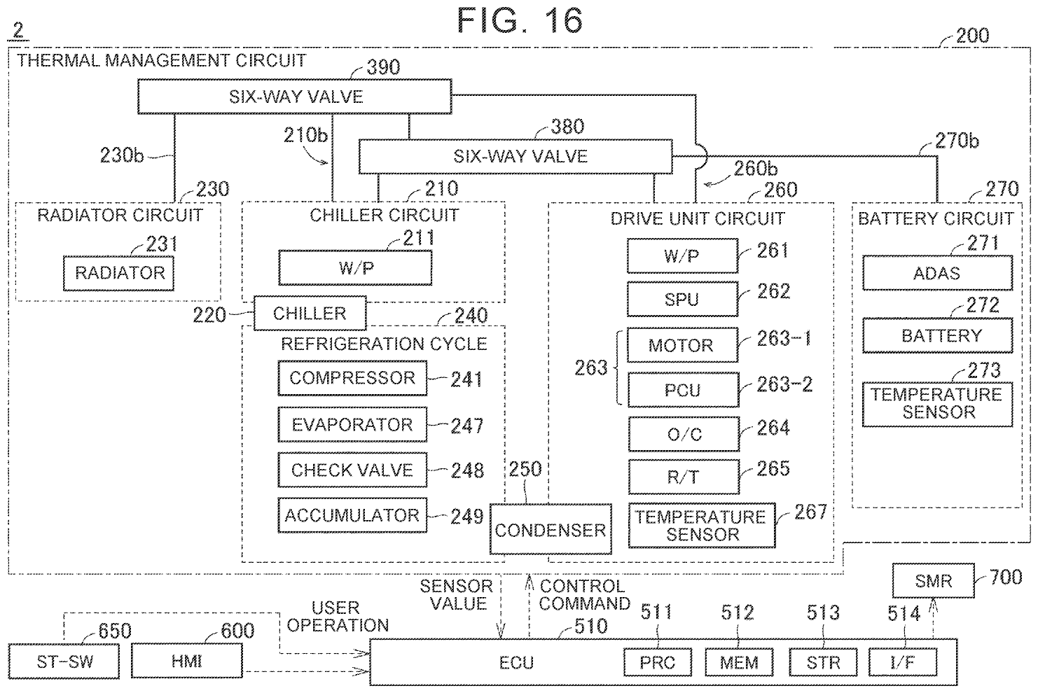

FIG. 16 shows an example of the overall configuration of a thermal management system 2 according to the second embodiment of the present disclosure. The thermal management system 2 is different from the thermal management system 1 according to the first embodiment (see FIG. 1) in that the thermal management system 2 includes a thermal management circuit 200 instead of the thermal management circuit 100 and includes an ECU 510 instead of the ECU 500.

The thermal management circuit 200 includes a chiller circuit 210, a chiller 220, a radiator circuit 230, a refrigeration cycle 240, a condenser 250, a drive unit circuit 260, a battery circuit 270, a six-way valve 380, and a six-way valve 390. The six-way valves 380, 390 are an example of the “switching device” of the present disclosure.

The chiller circuit 210 includes a water pump (W/P) 211. The chiller 220 is connected to (shared by) both the chiller circuit 210 and the refrigeration cycle 240. The chiller 220 is an example of the “chiller device” of the present disclosure.

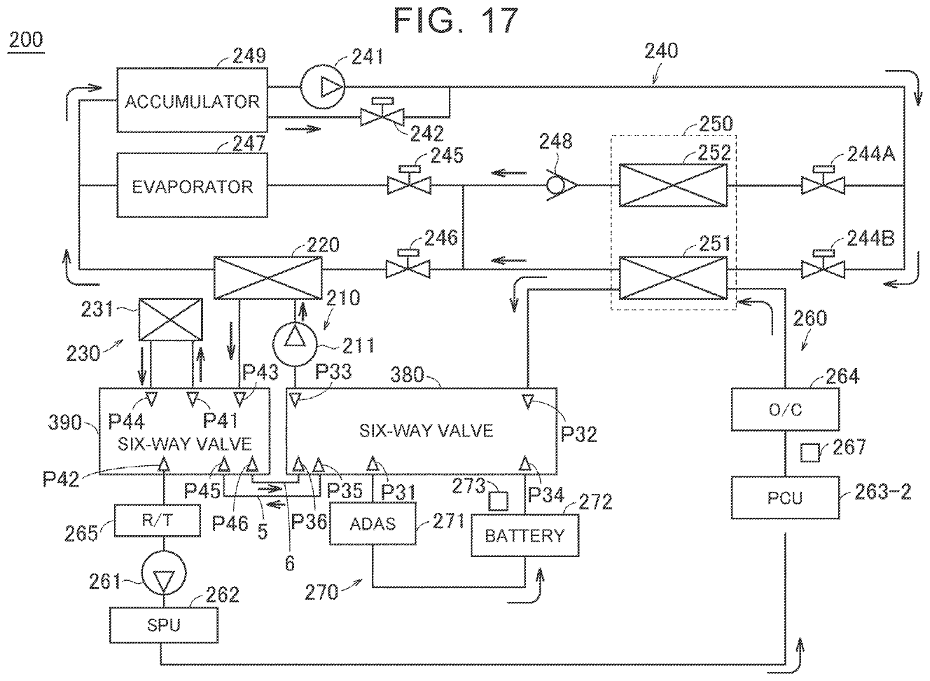

The radiator circuit 230 includes a radiator 231. The refrigeration cycle 240 includes a compressor 241, an electromagnetic valve 242 (see FIG. 17), electromagnetic valves 244A, 244B, 245, and 246 (see FIG. 17), an evaporator 247, a check valve 248, and an accumulator 249. The condenser 250 includes a water-cooled condenser 251 and an air-cooled condenser 252 (see FIG. 17), and the water-cooled condenser 251 is connected to both the refrigeration cycle 240 and the drive unit circuit 260. The chiller 220, the compressor 241, the accumulator 249, and the condenser 250 are an example of the “heating circuit” of the present disclosure.

The drive unit circuit 260 includes a water pump 261, an SPU 262, a transaxle 263 (motor 263-1 and PCU 263-2), an oil cooler 264, a reservoir tank 265, and a temperature sensor 267. The transaxle 263 is an example of the “drive device” of the present disclosure. The transaxle 263, a battery 272, and the SMR 700 are an example of the “traveling system” of the present disclosure.

The battery circuit 270 includes advanced driver-assistance systems (ADAS) 271, the battery 272, and a temperature sensor 273. The battery 272 is an example of the “electrical storage device” of the present disclosure. The temperature sensor 273 is an example of the “first temperature sensor” of the present disclosure.

The six-way valve 380 is connectable to the chiller circuit 210, the drive unit circuit 260, the battery circuit 270, and the six-way valve 390. The six-way valve 390 is connectable to the radiator circuit 230, the chiller circuit 210, the drive unit circuit 260, and the six-way valve 380.

The ECU 510 controls the thermal management circuit 200. The ECU 510 includes a processor 511, a memory 512, a storage 513, and an interface 514.

### Configuration of Thermal Management Circuit

FIG. 17 shows an example of the configuration of the thermal management circuit 200 according to the second embodiment. Referring to FIG. 17, the six-way valve 380 includes ports P31 to P36. The six-way valve 390 includes ports P41 to P46. The port P35 is connected to the port P45 via the bypass path 5. The port P36 is connected to the port P46 via the bypass path 6.

A heat medium circulating in the chiller circuit 210 flows through the following path: “six-way valve 380 (port P33)-water pump 211-chiller 220-six-way valve 390 (port P43).”

The water pump 211 circulates the heat medium in the chiller circuit 210 according to a control command from the ECU 510. The chiller 220 exchanges heat between the heat medium circulating in the chiller circuit 210 and the heat medium circulating in the refrigeration cycle 240. Each of the six-way valves 380, 390 switches the path to which the chiller circuit 210 is connected according to a control command from the ECU 510. The switching of the path by the six-way valves 380, 390 will be described in detail later.

In the example shown in FIG. 17, the heat medium that can flow through the radiator circuit 230 can flow through the following path: “six-way valve 390 (port P41)-six-way valve 390 (port P44).” The radiator 231 exchanges heat between the heat medium and the air outside the electrified vehicle 1a.

The heat medium (gas-phase refrigerant or liquid-phase refrigerant) circulating in the refrigeration cycle 240 flows through one of first to fourth paths. The first path is a path of “compressor 241-electromagnetic valve 244A-air-cooled condenser 252-check valve 248-electromagnetic valve (expansion valve) 245-evaporator 247-accumulator 249-compressor 241.” The second path is a path of “compressor 241-electromagnetic valve 244A-air-cooled condenser 252-check valve 248-electromagnetic valve (expansion valve) 246-chiller 220-accumulator 249-compressor 241.” The third path is a path of “compressor 241-electromagnetic valve 244B-water-cooled condenser 251-electromagnetic valve (expansion valve) 245-evaporator 247-accumulator 249-compressor 241.” The fourth path is a path of “compressor 241-electromagnetic valve 244B-water-cooled condenser 251-electromagnetic valve 246-chiller 220-accumulator 249-compressor 241.”

The compressor 241 compresses the gas-phase refrigerant circulating in the refrigeration cycle 240 according to a control command from the ECU 510. The electromagnetic valve 242 is connected in parallel with the compressor 241, and adjusts the amount of gas-phase refrigerant flowing into the compressor 241 according to a control command from the ECU 510. The electromagnetic valves 244A, 244B selectively allow the gas-phase refrigerant discharged from the compressor 241 to flow into either the water-cooled condenser 251 or the air-cooled condenser 252 according to a control command from the ECU 510. The water-cooled condenser 251 exchanges heat between the gas-phase refrigerant discharged from the compressor 241 and the heat medium flowing in the radiator circuit 230. The air-cooled condenser 252 exchanges heat with air introduced into the vehicle cabin to produce warm air.

The electromagnetic valve 245 restricts the flow of the liquid-phase refrigerant into the evaporator 247 according to a control command from the ECU 510. The electromagnetic valve 246 restricts the flow of the liquid-phase refrigerant into the chiller 220 according to a control command from the ECU 510. The electromagnetic valves 245, 246 also have a function to expand the liquid-phase refrigerant. The accumulator 249 removes the liquid-phase refrigerant from the refrigerant in a gas-liquid mixed state. The accumulator 249 thus reduces or prevents the liquid-phase refrigerant being sucked into the compressor 241 when the refrigerant is not completely evaporated by the evaporator 247.

The heat medium (coolant) circulating in the drive unit circuit 260 flows through the following path: “six-way valve 390 (port P42)-reservoir tank 265-water pump 261-SPU 262-PCU 263-2 (transaxle 263)-oil cooler 264-water-cooled condenser 251-six-way valve 380 (port P32).”

The water pump 261 circulates the heat medium in the drive unit circuit 260 according to a control command from the ECU 510. The SPU 262 controls charge and discharge of the battery 272 according to a control command from the ECU 510. The PCU 263-2 converts DC power supplied from the battery 272 to AC power to supply the AC power to the motor 263-1 of the transaxle 263 according to a control command from the ECU 510. The oil cooler 264 cools the transaxle 263 through heat exchange between the heat medium circulating in the drive unit circuit 260 and lubricating oil for the motor 263-1. Heat exchange may be performed between heat generated by supplying electric power to a stator without rotating a rotor of the motor 263-1 and the heat medium circulating in the drive unit circuit 260. The SPU 262, the PCU 263-2, and the oil cooler 264 are cooled by the heat medium circulating in the drive unit circuit 260.

The reservoir tank 265 stores part of the heat medium circulating in the drive unit circuit 260 (heat medium that has overflowed due to a pressure increase) to maintain the pressure and amount of heat medium in the drive unit circuit 260. The temperature sensor 267 is located downstream of the transaxle 263, and detects the temperature of the heat medium in a flow path 260b (described later). The temperature sensor 267 is an example of the “second temperature sensor” of the present disclosure.

The heat medium (coolant) circulating in the battery circuit 270 flows through the following path: “six-way valve 380 (port P31)-ADAS 271-battery 272-six-way valve 380 (port P34).”

The ADAS 271 includes auto speed limiter (ASL) and lane keeping assist (LKA). The battery 272 supplies electric power for traveling to the transaxle 263. The temperature sensor 273 detects the temperature of the battery 272.

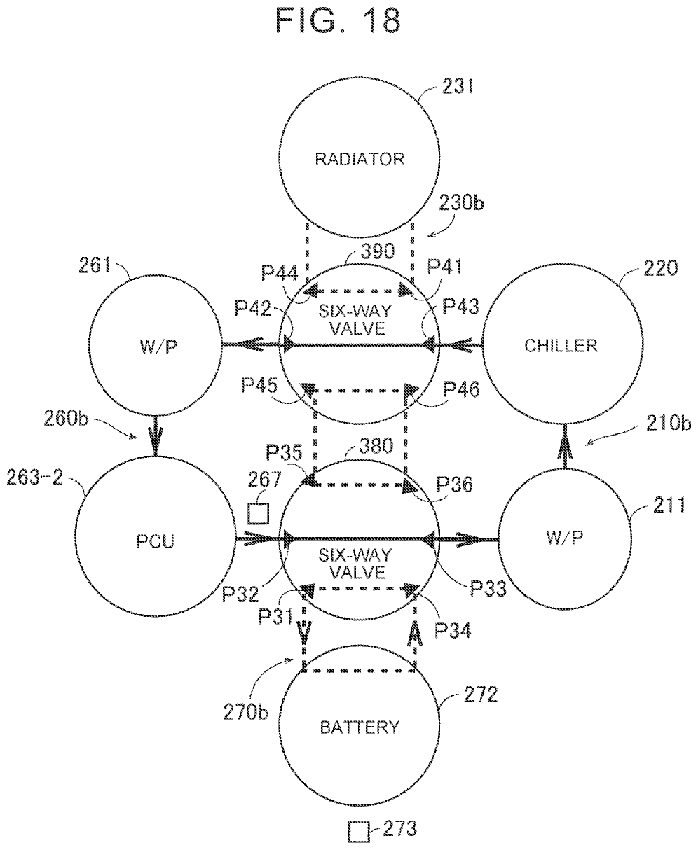

The chiller 220 is provided in a flow path 210b (see FIG. 18) of the chiller circuit 210. The flow path 210b is a flow path connecting the port P33 of the six-way valve 380 and the port P43 of the six-way valve 390. The flow path 210b is an example of the “fourth flow path” of the present disclosure.

The radiator 231 is provided in a flow path 230b (see FIG. 18) of the radiator circuit 230. The flow path 230b is a flow path connecting the port P41 and the port P44 of the six-way valve 390, and is an example of the “third flow path” of the present disclosure.

The water pump 261, the SPU 262, the PCU 263-2, the oil cooler 264, and the reservoir tank 265 (only the water pump 261 and the PCU 263-2 are representatively shown in FIG. 18) are provided in the flow path 260b (see FIG. 18) of the drive unit circuit 260. The PCU 263-2 (transaxle 263) etc. exchange heat with the heat medium in the flow path 260b. The flow path 260b is in thermal contact with the PCU 263-2 etc. The flow path 260b is a flow path connecting the port P42 of the six-way valve 390 and the port P32 of the six-way valve 380. The flow path 260b is an example of the “second flow path” of the present disclosure.

The battery 272 is provided in a flow path 270b (see FIG. 18) of the battery circuit 270. The flow path 270b is a flow path connecting the ports P31, P34 of the six-way valve 380. The battery 272 exchanges heat with the heat medium in the flow path 270b. The flow path 270b is in thermal contact with the battery 272. The flow path 270b is an example of the “first flow path” of the present disclosure.

### Communication Patterns

FIG. 18 is a conceptual diagram showing an overview of a reference communication pattern formed by the six-way valves 380, 390. When the traveling system is activated, the ECU 510 starts the heating control and controls the six-way valves 380, 390 to form the reference communication pattern (FIG. 18) during the heating control.

This reference communication pattern is different from the reference communication pattern of the first embodiment (FIG. 4) in that the water pumps 131, 171, the chiller 160, the low temperature radiator 122, the PCU 133-2, the battery 173, the temperature sensors 138, 175, the six-way valves 180, 190, and the flow paths 130a, 130b, 170a, 170b are replaced with the water pumps 261, 211, the chiller 220, the radiator 231, the PCU 263-2, the battery 272, the temperature sensors 267, 273, the six-way valves 390, 380, and the flow paths 230b, 260b, 210b, 270b, but has the same configuration and provides the same effects as those of the pattern of the first embodiment. Therefore, detailed description will not be repeated.

### Third Embodiment

In a third embodiment, an example in which the ten-way valve is used in a thermal management system different from the thermal management system 1 will be described. The same components as those of the second embodiment are denoted by the same signs as those of the second embodiment, and description thereof will not be repeated.

### Overall Configuration

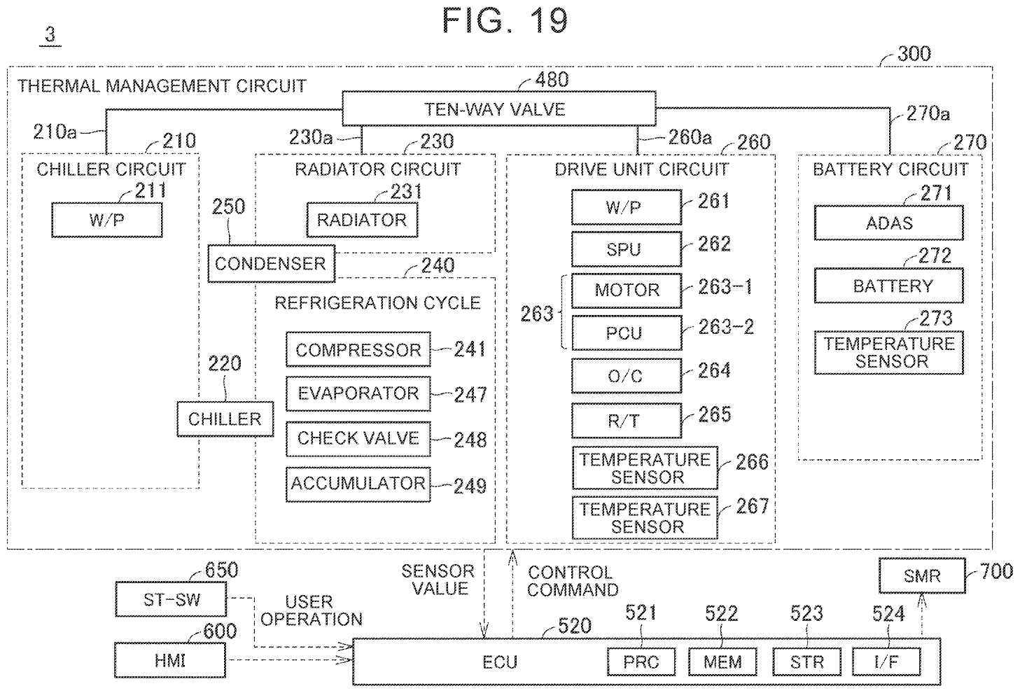

FIG. 19 shows an example of the overall configuration of a thermal management system 3 according to the third embodiment. The thermal management system 3 is different from the thermal management system 2 according to the second embodiment (see FIG. 16) in that the thermal management system 3 includes a thermal management circuit 300 instead of the thermal management circuit 200 and includes an ECU 520 instead of the ECU 510.

The thermal management circuit 300 includes the chiller circuit 210, the chiller 220, the radiator circuit 230, the refrigeration cycle 240, the condenser 250, the drive unit circuit 260, the battery circuit 270, and a ten-way valve 480. The ten-way valve 480 is an example of the “switching device” of the present disclosure.

The chiller 220 is provided in a flow path 210a of the chiller circuit 210. The flow path 210a connects the chiller circuit 210 and the ten-way valve 480. The flow path 210a is an example of the “fourth flow path” of the present disclosure.

The radiator 231 is provided in a flow path 230a. The flow path 230a connects the radiator 231 and the ten-way valve 480. The flow path 230a is an example of the “third flow path” of the present disclosure.

The water pump 261, the SPU 262, the transaxle 263, the oil cooler 264, and the reservoir tank 265 are provided in a flow path 260a of the drive unit circuit 260. The flow path 260a connects the drive unit circuit 260 and the ten-way valve 480. The flow path 260a is in thermal contact with the SPU 262, the transaxle 263, and the oil cooler 264. The transaxle 263 etc. thus exchange heat with the heat medium in the flow path 260a. The flow path 260a is an example of the “second flow path” of the present disclosure.

The battery 272 is provided in a flow path 270a of the battery circuit 270. The flow path 270a connects the battery circuit 270 and the ten-way valve 480. The flow path 270a is in thermal contact with the battery 272. The battery 272 thus exchanges heat with the heat medium in the flow path 270a. The flow path 270a is an example of the “first flow path” of the present disclosure.

The ECU 520 controls the thermal management circuit 300. The ECU 520 includes a processor 521, a memory 522, a storage 523, and an interface 524.

### Configuration of Thermal Management Circuit

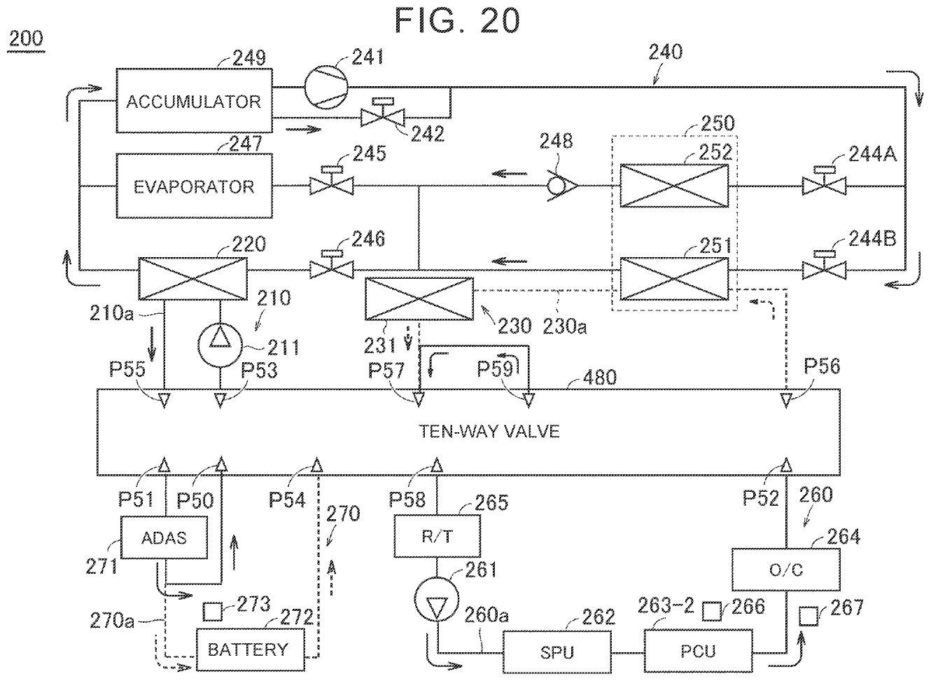

FIG. 20 shows an example of a specific configuration of the thermal management circuit 300 according to the third embodiment. As shown in FIG. 20, the ten-way valve 480 includes ports P50 to P59. The port P51 is connected to the port P54. The port P51 is connectable to the port P50 as well. The port P52 is connected to the port P58. The port P53 is connected to the port P55. The port P56 is connected to the port P57. The port P59 as well is connectable to the port P57.

The heat medium circulating in the chiller circuit 210 can flow through the flow path 210a that is a path of “ten-way valve 480 (port P53)-water pump 211-chiller 220-ten-way valve 480 (port P55).”

The heat medium circulating in the radiator circuit 230 can flow through the flow path 230a that is a path of “ten-way valve 480 (port P56)-water-cooled condenser 251-radiator 231-ten-way valve 480 (port P57).”

The heat medium (coolant) circulating in the drive unit circuit 260 can flow through the flow path 260a that is a path of “ten-way valve 480 (port P58)-reservoir tank 265-water pump 261-SPU 262-PCU 263-2 (transaxle 263)-oil cooler 264-ten-way valve 480 (port P52).”

The heat medium (coolant) circulating in the battery circuit 270 can flow through the flow path 270a that is a path of “ten-way valve 480 (port P51)-ADAS 271-battery 272-ten-way valve 480 (port P54).”

### Communication Patterns

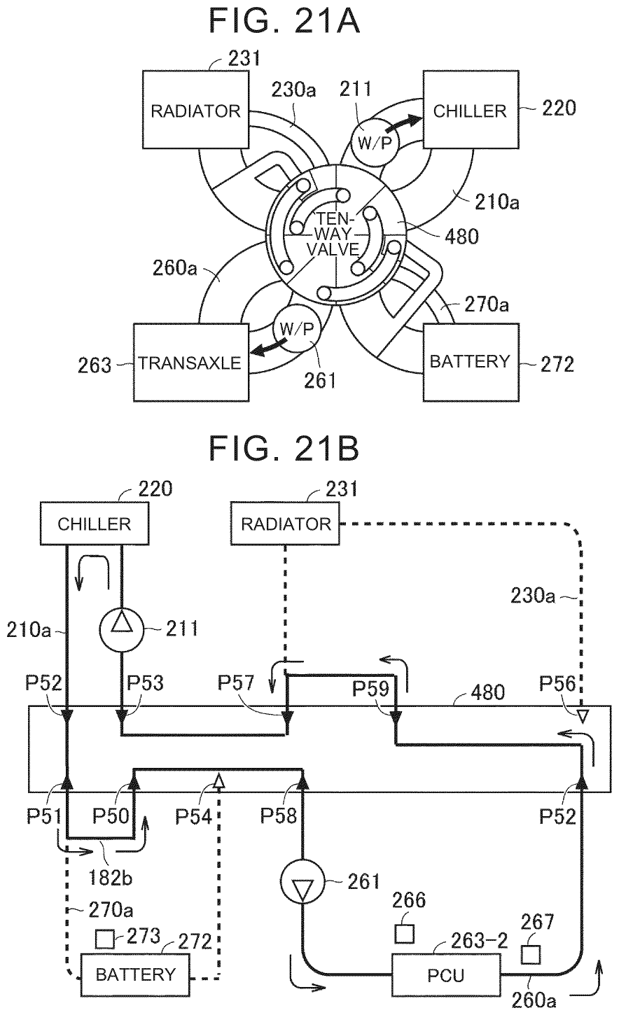

FIGS. 21A and 21B are conceptual diagrams showing an overview of a reference communication pattern of the thermal management circuit 300 that is formed by controlling the ten-way valve 480.

FIG. 21A schematically shows the relationship among the ten-way valve 480, the radiator 231, the transaxle 263, the chiller 220, and the battery 272. FIG. 21B illustrates in detail how the heat medium flows in the circuit shown in FIG. 21A. The ECU 520 forms the reference communication pattern (FIGS. 21A and 21B) when performing the heating control.

This reference communication pattern is different from the reference communication pattern of the fifth modification of the first embodiment (FIGS. 15A and 15B) in that the water pumps 131, 171, the chiller 160, the low temperature radiator 122, the transaxle 133 (PCU 133-2), the battery 173, the temperature sensors 138, 175, the ten-way valve 280, and the flow paths 130a, 130b, 170a, 170b are replaced with the water pumps 261, 211, the chiller 220, the radiator 231, the transaxle 263 (PCU 263-2), the battery 272, the temperature sensors 267, 273, the ten-way valve 480, and the flow paths 230a, 260a, 210a, 270a, but has the same configuration and provides the same effects as those of the pattern of the fifth modification. Therefore, detailed description will not be repeated.

### Other Modifications

The first to third embodiments illustrate an example in which the ECU performs the heating control of the battery at the start of driving of the electrified vehicle 1a (when the traveling system is activated). However, the present disclosure is not limited to this.

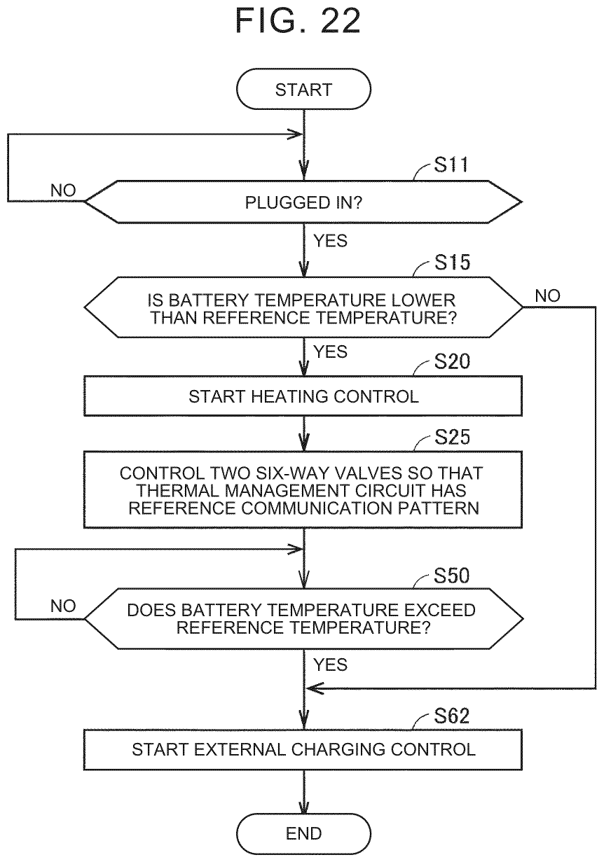

FIG. 22 is a flowchart illustrating a process that is performed by the ECU according a modification. Referring to FIG. 22, the ECU may perform the heating control so that the temperature of the battery 173 becomes equal to or higher than a predetermined reference temperature at the start of external charging (see S62 in FIG. 22). For example, when the ECU detects in step S11 that a charging plug of charging equipment is plugged (inserted) into the inlet 178, the process proceeds to step S15. When it is determined in step S15 that the temperature of the battery 173 is equal to or higher than the reference temperature or when it is determined in step S50 that the temperature of the battery 173 exceeds the reference temperature, the process proceeds to step S62. In step S62, the ECU starts external charging control. FIG. 22 illustrates an example in which plugging in triggers the heating control. However, the heating control may be started before plugging in. For example, the heating control may be started a predetermined time (e.g., 10 minutes) before the scheduled start time of external charging (scheduled start time of supplying charging power). In this example, the above control is representatively applied to the first embodiment. However, the above control may be applied to the second or third embodiment.

The first to third embodiments illustrate an example in which the thermal management system is mounted on an electrified vehicle. However, the present disclosure is not limited to this. The thermal management system may be mounted on an electrical apparatus different from an electrified vehicle (e.g., a stationary electrical apparatus).

The first embodiment illustrates an example in which the thermal management circuit 100 includes the high temperature circuit 110. However, the present disclosure is not limited to this. The thermal management circuit 100 need not include the high temperature circuit 110.

The first to third embodiments illustrate an example in which the battery heating control is performed at the start of driving of the electrified vehicle 1a (when the traveling system is activated). However, the present disclosure is not limited to this. The heating control need not be performed at the start of driving of the electrified vehicle 1a (when the traveling system is activated). For example, the heating control may be performed when the battery temperature falls below a reference temperature. In this case, the ECU may acquire the detected value of the battery temperature at predetermined intervals (e.g., every hour).

The embodiments and modifications thereof may be combined as appropriate. For example, the first, second, or third modification of the first embodiment may be combined with the second or third embodiment.

The electrified vehicle 1a may be a hybrid electric vehicle (HEV), a plug-in hybrid electric vehicle (PHEV), or a fuel cell electric vehicle (FCEV). However, the thermal management system according to the present disclosure is not limited to vehicle applications.

### Battery Heating Control

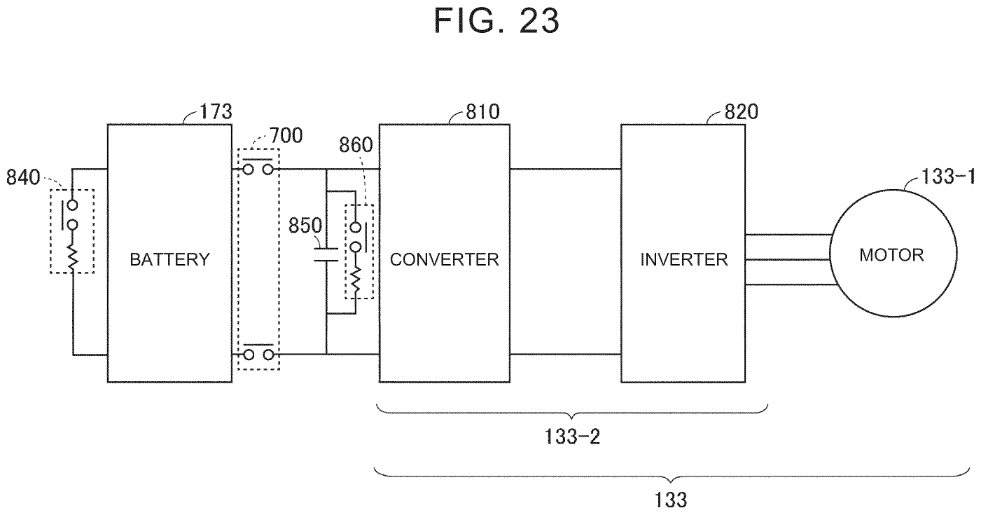

FIG. 23 illustrates the battery heating control in detail. Referring to FIG. 23, the PCU 133-2 includes a converter 810 and an inverter 820. The battery 173 is connected to the converter 810 via the SMR 700. The converter 810 is connected to the inverter 820. The inverter 820 is connected to the motor 133-1. A discharge circuit 840 including a switch and a resistive element is connected to the battery 173. A smoothing capacitor 850 is provided between the battery 173 and the converter 810. A discharge circuit 860 includes a switch and a resistive element, and is connected in parallel with the smoothing capacitor 850. FIG. 23 is representatively illustrated based on the configuration of the first embodiment. However, the same configuration may be applied to any of the second and third embodiments and their modifications.

The heating control of the battery 173 may include, for example, control for electrically disconnecting the SMR 700 and turning on the switch of the discharge circuit 840. A current thus flows through a closed circuit formed by the battery 173 and the discharge circuit 840. The heating control of the battery 173 may include control for turning off the switch of the discharge circuit 840 and turning on the SMR 700 and the switch of the discharge circuit 860. A current thus flows through a closed circuit formed by the battery 173, the SMR 700, and the discharge circuit 860. The heating control of the battery 173 may include control for turning on the SMR 700 and turning off the switches of the discharge circuits 840, 860 to cause a current adjusted so that no torque is generated in the motor 133-1 to flow.

The embodiments disclosed herein should be construed as illustrative in all respects and not restrictive. The scope of the present disclosure is set forth in the claims rather than in the above description of the embodiments, and is intended to include all modifications within the meaning and scope equivalent to those of the claims.

What is claimed is:

1. A thermal management system mounted on an electrical apparatus, the thermal management system comprising:
a first flow path, a second flow path, a third flow path, and a fourth flow path configured such that a heat medium flows through the first flow path, the second flow path, the third flow path, and the fourth flow path;
an electrical storage device configured to exchange heat with the heat medium in the first flow path;
a drive device configured to exchange heat with the heat medium in the second flow path and configured to generate a driving force;
a radiator located in the third flow path;
a chiller device located in the fourth flow path; and
a switching device configured to switch a connection state among the first flow path, the second flow path, the third flow path, and the fourth flow path, wherein
the switching device is configured to cause a switching circuit to be formed, the switching circuit being a circuit in which the first flow path is disconnected from and independent of the second flow path, the third flow path, and the fourth flow path, the second flow path is connected to the fourth flow path, and the third flow path is disconnected from and independent of the second flow path and the fourth flow path.

2. The thermal management system according to claim 1, wherein the electrical apparatus is an electrified vehicle.

3. The thermal management system according to claim 2, wherein the switching device is configured to cause the switching circuit to be formed while heating of the electrical storage device is performed by causing a current to flow through the electrical storage device.

4. The thermal management system according to claim 3, wherein the electrical storage device is heated after a traveling system of the electrified vehicle is activated.

5. The thermal management system according to claim 3, wherein:
the electrical storage device is configured such that external charging is performed, the external charging being charging of the electrical storage device with charging power supplied from charging equipment external to the electrified vehicle; and
the electrical storage device is heated to cause a temperature of the electrical storage device to be a predetermined temperature or higher at start of the external charging.

6. The thermal management system according to claim 2, further comprising a heating circuit configured to exchange heat via the chiller device and heat a vehicle cabin of the electrified vehicle, wherein in a case where heating of the vehicle cabin is requested, heat from the drive device is supplied to the heating circuit via the chiller device by driving the heating circuit with the switching circuit provided.

7. The thermal management system according to claim 3, further comprising:
a first temperature sensor configured to detect a temperature of the electrical storage device; and
a second temperature sensor configured to detect a temperature of the heat medium flowing through the second flow path and the fourth flow path, wherein the switching circuit is switched to connect the first flow path to the second flow path and the fourth flow path in response to a detected value from the second temperature sensor exceeding a detected value from the first temperature sensor during the heating of the electrical storage device with the switching circuit provided.

8. The thermal management system according to claim 1, wherein the switching circuit is switched to connect the third flow path to the second flow path and the fourth flow path in response to frost being detected on the radiator while the switching circuit is provided.

9. The thermal management system according to claim 1, further comprising a control device configured to control the switching device.
